(19) United States
(12) Patent Application Publication
(10) Pub. No.: US 2010/0134377 A1
(43) Pub. Date: Jun. 3, 2010

(54) PLANAR ANTENNA

(75) Inventors: Hsiao-Ming Tsai, Taipei (TW); Ten-Long Dan, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/399,038

(22) Filed: Mar. 6, 2009

(30) Foreign Application Priority Data
Nov. 28, 2008 (TW) 97146340

(51) Int. Cl. H01Q 21/00; H01Q 1/50

(52) U.S. Cl. 343/852; 343/893

(57) ABSTRACT

A planar antenna including a substrate, multiple antenna bodies and a metal layer is provided. The antenna bodies are disposed at a surface of the substrate, and the metal layer is disposed at another surface of the substrate. The metal layer has multiple slots which interlace with the antenna bodies. The antenna bodies are partially corresponding to the metal layer and used to cooperate with a communication system which can perform a multi-path transmission to send and receive electromagnetic signals for a multiple MIMO system simultaneously.

### CROSS-REFERENCE TO RELATED APPLICATION

This application claims the priority benefit of Taiwan application serial no. 97146340, filed Nov. 28, 2008. The entirety of the above-mentioned patent application is hereby incorporated by reference herein and made a part of specification.

### BACKGROUND OF THE INVENTION

1. Field of the Invention

The invention relates to an antenna and, more particularly, to a planar antenna.

2. Description of the Related Art

In recent years, to meet the users' growing demand for the connection between computers and various peripheral equipment or consumptive devices, electronic devices nowadays need various built-in wireless communication functions such as the global positioning system (GPS), the Global system for mobile communications (GSM), the wireless local area network (WLAN), the wireless metropolitan area network (WMAN) and so on.

With the progress and the development of hardware equipment and technology used in wireless communication system, the multi-input multi-output (MIMO) technology is gradually used in the WLAN, the worldwide interoperability for microwave access (WIMAX), the long term evolution (LTE) and other systems. Multiple antennas in the MIMO system operate together, and thus compared with the conventional system having a single antenna, the MIMO system has the characteristic that the reliability, the transmission speed and the receiving scope are improved. This makes the MIMO technology become a mainstream technology used in the wireless communication in the future. To increase the transmission speed, multiple MIMO systems may be disposed in a product in the future.

In the communication network which mainly uses the MIMO technology, multiple antennas should be disposed in an electronic device to form a multi-path transmission mechanism. In addition, to make the MIMO system have the best transmission speed, isolation of each antenna should be more than 15 dB. However, in the present electronic devices, the isolation of the antenna is improved by increasing the distances between the antennas. This not only consumes large space in the electronic device, but also limits the microminiaturization of the electronic devices.

### BRIEF SUMMARY OF THE INVENTION

The invention provides a planar antenna in which multiple antenna bodies and a metal layer are disposed on a substrate to reduce its volume.

The invention provides a planar antenna which may use more than two MIMO systems and has the benefit for the microminiaturization of the electronic device.

The invention provides a planar antenna including a substrate, multiple antenna bodies and a metal layer. The multiple antenna bodies are disposed at a surface of the substrate, and the metal layer is disposed at another surface of the substrate. In addition, the metal layer has multiple slots interlacing with the multiple antenna bodies, respectively. In addition, the multiple antenna bodies are partially corresponding to the metal layer and used to cooperate with a communication system which can perform a multipath transmission to send and receive electromagnetic signals for a multiple MIMO system simultaneously.

In an embodiment of the invention, each of the multiple antenna bodies includes a feeding portion and a radiation portion, respectively. The feeding portion is corresponding to the metal layer. The radiation portion is electrically connected to the feeding portion and used to send or receive electromagnetic signals. In addition, the radiation portion includes a first conducting sheet and a second conducting sheet. The first conducting sheet is shaped like a trapezoid or the shape similar to a trapezoid and electrically connected to the feeding portion. The second conducting sheet is rectangle-shaped, and it is electrically connected to the first conducting sheet.

In an embodiment of the invention, in the communication system, the multi-path transmission is formed using the multiple MIMO technology.

In another aspect, the invention also provides a planar antenna including a substrate, a metal layer and multiple antenna bodies. The metal layer and the multiple antenna bodies are disposed at a surface of the substrate. Multiple slots are located at an edge of the metal layer. The multiple antenna bodies are electrically connected to the metal layer and interlace with the multiple slots at the two sides of the edge of the metal layer. In addition, the multiple antenna bodies are used to cooperate with a communication system which can perform the multi-path transmission to send and receive electromagnetic signals for a multiple MIMO system.

In an embodiment of the invention, each of the multiple antenna bodies includes a ground portion and a radiation portion, respectively. The ground portion is substantially perpendicular to the substrate and electrically connected to an edge of the metal layer. The radiation portion is substantially parallel with the substrate and electrically connected to the ground portion. In addition, the radiation portion is used to send or receive electromagnetic signals.

Based on these above, in the planar antenna of the invention, the isolation of the antenna bodies is improved by the relative positions of the multiple slots of the metal layer and the antenna bodies. Furthermore, the planar antenna has the advantage of being small in volume, and it may be used in the multiple MIMO system. Thus, compared with the conventional technology, the electronic device may be combined with the planar antenna in the invention to provide better communication capability, and it also may be developed towards the trend of microminiaturization.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing the structure of a planar antenna according to an embodiment of the invention;

FIG. 2 is a schematic diagram showing the structure of the antenna body 120 and a corresponding matching circuit; and

FIG. 3 is a schematic diagram showing the structure of a planar antenna in another embodiment of the invention.

### DETAILED DESCRIPTION OF THE EMBODIMENTS

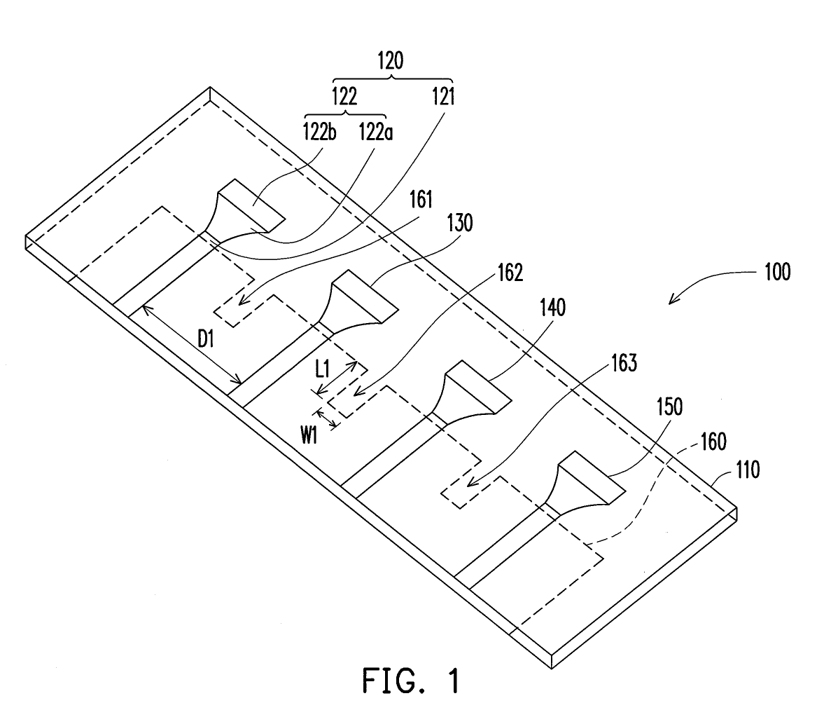

FIG. 1 is a schematic diagram showing the structure of a planar antenna according to an embodiment of the invention. As shown in FIG. 1, the planar antenna 100 includes a substrate 110, multiple antenna bodies 120 to 150 and a metal layer 160. The substrate 110 is, for example, a printed circuit board. The antenna bodies 120 to 150 are disposed at a surface of the substrate 110, and the metal layer 160 is disposed at another surface of the substrate 110. In addition, the antenna bodies 120 to 150 are partially corresponding to the metal layer 160 to make partial area of each of the antenna bodies 120 to 150 correspond to the metal layer 160.

Furthermore, the metal layer 160 has multiple slots 161 to 163. Seen perspectively, the slots 161 to 163 and the antenna bodies 120 to 150 are disposed alternately, and this makes the slots 161 to 163 interlace with the antenna bodies 120 to 150. In the embodiment, each of the slots 161 to 163 interlaces between the two adjacent antenna bodies, respectively.

For example, the slot 161 is located between the two adjacent antenna bodies 120 and 130. The slot 162 is located between the two adjacent antenna bodies 130 and 140. Thus, the position of the slot 163 is known by analogy. Although a mode of locating the slots 161 to 163 is provided in the embodiment, the scope of the invention should not be limited thereto. A skilled person in the art may change the distances between each of the slots 161 to 163 and the two adjacent antenna bodies according to the design requirement.

In another aspect, each of the antenna bodies 120 to 150 includes a feeding portion and a radiation portion, respectively. For example, the antenna body 120 includes a feeding portion 121 and a radiation portion 122. The feeding portion 121 is corresponding to the metal layer 160 and electrically connected to the radiation portion 122. The structures of the antenna bodies 130 to 150 are the same as that of the antenna body 120, and they are not illustrated herein for concise purpose.

Besides, in the embodiment, the radiation portions of the antenna bodies 120 to 150 are composed of two conducting sheets with particular shapes. For example, the radiation portion 122 of the antenna body 120 includes a conducting sheet 122a and a conducting sheet 122b. The conducting sheet 122a is shaped like a trapezoid or the shape similar to a trapezoid. The conducting sheet 122b is rectangle-shaped. In addition, the conducting sheet 122a and the conducting sheet 122b are electrically connected to each other. The conducting sheet 122a is further electrically connected to the feeding portion 121 of the antenna body 120. The conducting sheets 122a and 122b with particular shapes herein make the radiation portion 122 have preferred ability to send or receive electromagnetic signals.

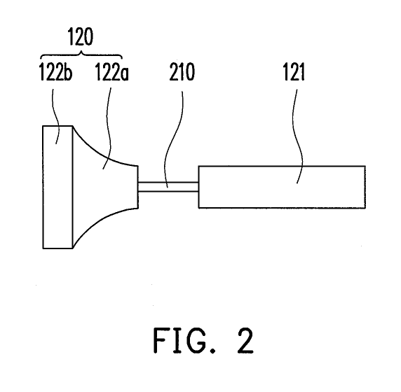

To improve the sending and receiving ability of the antenna bodies 120 to 150, a skilled person in the art may design a corresponding matching circuit according to each of the antenna bodies 120 to 150. For example, FIG. 2 is a schematic diagram showing the structure of the antenna body 120 and a corresponding matching circuit. As shown in FIG. 2, the planar antenna 200 further includes a matching circuit 210. The matching circuit 210 is corresponding to the antenna body 120 and electrically connected between the feeding portion 121 of the antenna body 120 and the radiation portion 122. Impedance of the feeding portion 121 is matched with the impedance of the radiation portion 122 through the matching circuit 210 to improve the sending and receiving ability of the antenna body 120.

As shown in FIG. 1, the planar antenna 100 mainly uses the antenna bodies 120 to 150 to send and receive electromagnetic signals. The antenna bodies 120 to 150 are used to cooperate with a communication system which can perform a multi-path transmission to send and receive electromagnetic signals for a multiple MIMO system simultaneously. In the communication system, the multi-path transmission may be formed using the MIMO technology. In other words, the planar antenna 100 in the embodiment may be adapted for the MIMO system. Besides, since the planar antenna 100 has the advantage of being small in volume, it is benefit for the microminiaturization of the electronic device.

For example, in actual application, when the antenna bodies 120 to 150 are operated in the 5 GHz radio-frequency range, that is, when the antenna bodies 120 to 150 are used to send and receive 5 GHz electromagnetic signals, the distance between two adjacent antenna bodies of the antenna bodies 120 to 150 (such as the D1 denoted in FIG. 1) may be designed to be 20 millimeters to 28 millimeters. The widths of the slots 161 to 163 (such as the W1 denoted in FIG. 1) may be designed to be 4 millimeters to 5 millimeters. The depths of the slots 161 to 163 (such as the L1 denoted in FIG. 1) may be designed to be 8 millimeters to 10 millimeters. The planar antenna 100 herein has the advantage of being small in volume, and the isolation of the antenna bodies 120 to 150 may be kept more than 18 dB.

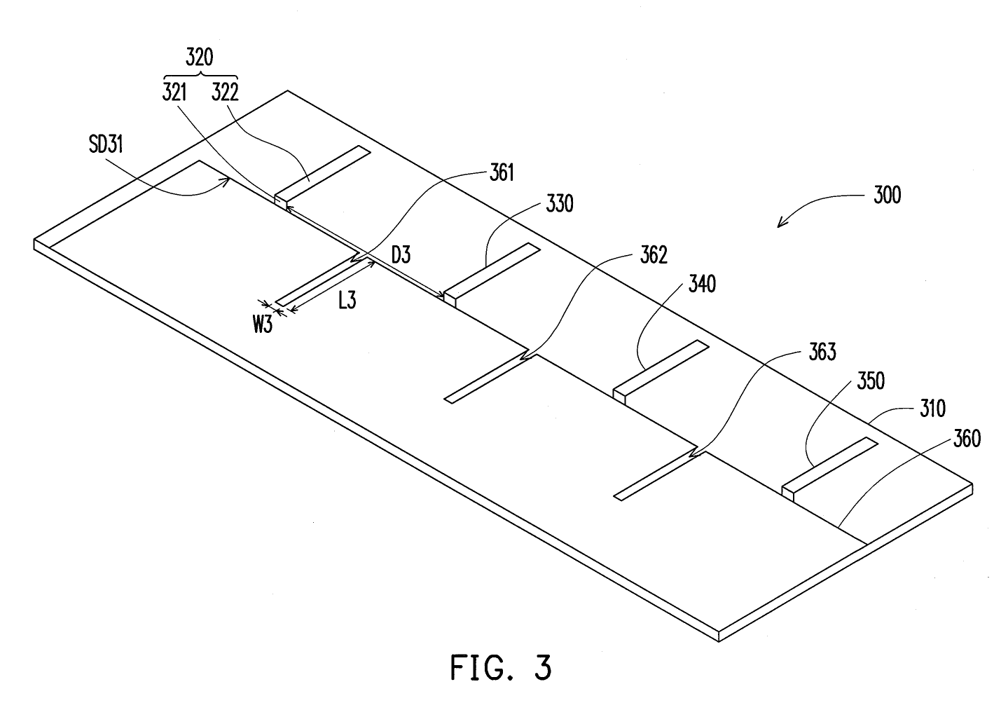

FIG. 3 is a schematic diagram showing the structure of a planar antenna in another embodiment of the invention. As shown in FIG. 3, the planar antenna 300 includes a substrate 310, multiple antenna bodies 320 to 350 and a metal layer 360. The substrate 310 is, for example, a printed circuit board. The antenna bodies 320 to 350 and the metal layer 360 are disposed on a surface of the substrate 310. In addition, multiple slots 361 to 363 are located at an edge SD31 of the metal layer 360. The antenna bodies 320 to 350 interlace with the slots 361 to 363 at the two sides of the edge SD31 of the metal layer 360.

In the embodiment, each of the slots 360 to 363 keeps equal distances from the adjacent two antenna bodies. For example, seen along the edge SD 31 of the metal layer 360, the distance between the slot 361 and the antenna body 320 is equal to the distance between the slot 361 and the antenna body 330. Similarly, in the embodiment, the distance between the slot 362 and the antenna body 330 is also equal to the distance between the slot 362 and the antenna body 340. By parity of reasoning, the position of the slot 363 is known. Although a mode of locating the slots 361 to 363 is provided in the embodiment, the scope of the invention should not be limited thereto. A skilled person in the art may change the distances between each of the slots 361 to 363 and two adjacent antenna bodies according to the design requirement.

Furthermore, each of the antenna bodies 320 to 350 includes a ground portion and a radiation portion, respectively. For example, the antenna body 320 includes a ground portion 321 and a radiation portion 322. The ground portion 321 is substantially perpendicular to the substrate 310 and electrically connected to the edge SD31 of the metal layer 360. The radiation portion 322 is substantially parallel with the substrate 310 and electrically connected to the ground portion 321. The structures of the antenna bodies 330 to 350 are the same as that of the antenna body 320, and they are not illustrated herein for concise purpose.

As shown in FIG. 3, the planar antenna 300 mainly sends and receives electromagnetic signals through the antenna bodies 320 to 350. The antenna bodies 320 to 350 cooperate with a communication system which can perform the multi-path transmission to send and receive electromagnetic signals for a multiple MIMO system simultaneously. In a communication system, the multi-path transmission is formed using the MIMO technology. In other words, the planar antenna 300 in the embodiment may be adapted for the multiple MIMO system, and it has the advantage of microminiaturization.

For example, in actual application, when the antenna bodies 320 to 350 are operated in 2.4 GHz radio-frequency range, that is, when the antenna bodies 320 to 350 are used to send and receive 2.4 GHz electromagnetic signals, distance between two adjacent antenna bodies of the antenna bodies 320 to 350 (such as the D3 denoted in FIG. 3) may be designed to be 40 millimeters to 50 millimeters. The widths of the slots 361 to 363 (such as the W3 denoted in FIG. 3) may be designed to be 1.5 millimeters to 1.9 millimeters. The depths of the slots 361 to 363 (such as the L3 denoted in FIG. 3) may be designed to be 18 millimeters to 20 millimeters. The planar antenna 300 herein has the advantage of being small in volume, and the isolation of the antenna bodies 320 to 350 can be kept more than 18 dB.

To sum up, in the invention, multiple antenna bodies and a metal layer are disposed at the substrate simultaneously to form a planar antenna having the advantage of microminiaturization. The isolation of the antenna bodies of the planar antenna also may be improved by the relative position of the slots of the metal layer and the antenna bodies. Thus, the planar antenna in the invention may be adapted for the MIMO system, and it also has preferable sending and receiving ability and small volume. Relatively, the planar antenna also may improve the microminiaturization of the electronic device.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A planar antenna comprising:
a substrate;
multiple antenna bodies, disposed at a surface of the substrate, for cooperating with a communication system which can perform multi-path transmission to send and receive electromagnetic signals for a multiple MIMO system simultaneously;
a metal layer disposed at another surface of the substrate and having multiple slots, wherein the antenna bodies are partially corresponding to the metal layer, and the slots interlace with the antenna bodies, respectively.

2. The planar antenna according to claim 1, wherein each of the antenna bodies comprises:
a feeding portion corresponding to the metal layer; and
a radiation portion electrically connected to the feeding portion and used to send or receive electromagnetic signals.

3. The planar antenna according to claim 2, further comprising:
multiple matching circuits corresponding to the antenna bodies in a one-to-one mode and connected between the feeding portions and the radiation portions of the corresponding antenna bodies, respectively.

4. The planar antenna according to claim 2, wherein the radiation portion comprises:
a first conducting sheet shaped like a trapezoid or similar to a trapezoid and electrically connected to the feeding portion; and
a second conducting sheet shaped like a rectangle and electrically connected to the first conducting sheet.

5. The planar antenna according to claim 1, wherein the slots interlace with two adjacent antenna bodies, respectively.

6. The planar antenna according to claim 1, wherein in the communication system, the multi-path transmission is formed using a multi-input multi-output (MIMO) technology.

7. The planar antenna according to claim 1, wherein the substrate is a printed circuit board.

8. The planar antenna according to claim 1, wherein the distance between two adjacent antenna bodies of the antenna bodies is 20 millimeters to 28 millimeters.

9. The planar antenna according to claim 1, wherein the widths of the slots are four millimeters to five millimeters, and the depths of the slots are eight millimeters to ten millimeters.

10. The planar antenna according to claim 1, wherein the antenna bodies are used to send or receive five GHz electromagnetic signals.

11. A planar antenna comprising:
a substrate;
a metal layer disposed at a surface of the substrate, wherein multiple slots are located at an edge of the metal layer; and
multiple antenna bodies electrically connected to the metal layer and interlacing with the slots at the two sides of the edge of the metal layer, wherein the antenna bodies are used to cooperate with a communication system which can perform multi-path transmission to send and receive electromagnetic signals simultaneously.

12. The planar antenna according to claim 11, wherein each of the antenna bodies comprises:
a ground portion substantially perpendicular to the substrate and electrically connected to the edge of the metal layer; and
a radiation portion substantially parallel with the substrate and electrically connected to the ground portion, wherein the radiation portion is used to send or receive electromagnetic signals.

13. The planar antenna according to claim 11, wherein each of the slots keeps equal distances from the two adjacent antenna bodies, respectively.

14. The planar antenna according to claim 11, wherein in the communication system, the multi-path transmission is formed by using more than two MIMO technologies.

15. The planar antenna according to claim 11, wherein the substrate is a printed circuit board.

16. The planar antenna according to claim 11, wherein the distance between two adjacent antenna bodies of the antenna bodies is 40 millimeters to 60 millimeters.

17. The planar antenna according to claim 11, wherein the widths of the slots are 1.5 millimeters to 1.9 millimeters, and the depths of the slots are 18 millimeters to 20 millimeters.

18. The planar antenna according to claim 11, wherein the antenna bodies are used to transmit 2.4 GHz electromagnetic signals.
